(19) United States
(12) Patent Application Publication
(10) Pub. No.: US 2006/0102210 A1
(43) Pub. Date: May 18, 2006

(54) Substrate processing container

(76) Inventors: Yasuhiro Chouno, Tosu-Shi, Saga-Ken (JP); Norihiro Ito, Tosu-Shi, Saga-Ken (JP)

Correspondence Address: SMITH, GAMBRELL & RUSSELL, LLP, 1850 M STREET, N.W., SUITE 800, WASHINGTON, DC, 20036, US

(21) Appl. No.: 10/522,155

(22) PCT Filed: Jul. 25, 2003
(86) PCT No.: PCT/JP03/09471

§ 371 Date: Nov. 4, 2005

(30) Foreign Application Priority Data
Jul. 25, 2002 (JP) 2002-216123

(51) Int. Cl. B08B 3/04

(52) U.S. Cl. 134/148; 134/186; 134/902; 134/157; 134/200

(57) ABSTRACT

A substrate processing vessel has a vessel body 100 and a cover 130 hermetically joined to the vessel body 100. The vessel body 100 is provided with a plurality of substrate support rods 102. Each of the support rods 102 has a shank 103 and a head 104 having a diameter greater than that of the shank 103 and attached to the upper end of the shank 103. The shanks 103 penetrate the vessel body 100 and project downward from the vessel body 100. When each substrate support rod 102 is lowered to its lower position, the head 104 is seated hermetically on a part, around the open upper end of a through hole 108 through which the shank 103 is inserted, of the vessel body 100. When each substrate support rod 102 is raised to its upper position, a space of a big thickness capable of receiving a wafer carrying arm 14a is formed between the upper surface of the vessel body 100 and a wafer W supported on the substrate support rods 102. A processing space defined by the substrate processing vessel may be very thin, the amount of a processing fluid necessary for processing the wafer W can be reduced and throughput can be increased.

### TECHNICAL FIELD

The present invention relates to a substrate processing vessel defining a sealed space for processing therein a substrate, such as a semiconductor wafer or an LCD glass substrate.

### BACKGROUND ART

Generally, in a semiconductor device manufacturing, a predetermined circuit pattern is formed on a semiconductor wafer (hereinafter referred to simply as “wafer”) by photolithography. A circuit pattern forming method includes a step of forming a resist film on a cleaned wafer by applying a liquid photoresist, a step of exposing the resist film with a predetermined pattern, a step of developing the exposed resist film, a step of etching the wafer and doping the wafer when necessary, and a step of removing the resist film from the wafer.

A recently proposed method of removing a resist film from a wafer includes steps of changing the properties of the resist film into water-soluble by using a process gas containing steam and ozone gas, and thereafter washing off the resist film from the wafer.

FIG. 15 is a schematic sectional view of a processing vessel 200 for carrying out a process for rendering a resist film water-soluble. The processing vessel 200 has a fixed vessel body 201 and a vertically movable cover 202. The cover 202 is moved vertically for opening and closing the processing vessel 200. A stage 203 is arranged on the vessel body 201. The upper surface of the stage 203 is provided with a plurality of support pins 203a for supporting a wafer W. A gas supply port 240 through which a process gas is supplied into the processing vessel 200 and a gas discharge port 205 through which the process gas is discharged are formed opposite to each other in the side wall of the vessel body 201. Heaters 206a and 206b are embedded in the cover 202 and the stage 203, respectively, to heat a wafer supported on the support pins 203a at a predetermined temperature. The wafer W is transferred to and from the support pin 203a by a carrying arm, not shown.

The support pins 203a of the processing vessel of such construction must have a length not shorter than 10 mm to enable the carrying arm to transfer the wafer W to and from the support pins 203a smoothly without colliding with the stage 203. Therefore, the processing space in the processing vessel 200 has a big height and thus a large volume. Consequently, the amount of the process gas for one processing cycle is large and the running cost is high. Moreover, the process gas flows irregularly in the processing vessel and the in-plane uniformity of the process deteriorates. A processing system including a plurality of such processing vessels is inevitably large. Since the wafer W is spaced a long distance apart from the stage 203, the wafer W cannot be heated efficiently and the throughput is low. Since the temperature distribution in the surface of the wafer W is irregular and hence the in-plane uniformity of the process deteriorates.

### SUMMARY OF THE INVENTION

The present invention has been made in view of the foregoing circumstances and it is therefore an object of the present invention to provide a substrate processing vessel provided with a substrate support structure that enables forming the processing vessel in low profile and in a small internal volume.

Another object of the present invention is to provide a substrate processing vessel capable of improving processing uniformity.

Another object of the present invention is to provide a substrate processing vessel capable of increasing throughput.

In order to achieve the objectives, the present invention provides a substrate processing vessel for processing therein a substrate with a processing fluid, which includes: a vessel body;

a cover adapted to be separatably and hermetically joined to the vessel body to define a processing space together with the vessel body; a plurality of substrate support rods incorporated into the vessel body; and a driving device adapted to vertically move the substrate support rods between a first vertical position and a second vertical position; wherein each of the substrate support rods has a head adapted to support a substrate from below the same, and a shank extending downward from the head, the vessel body is provided with a plurality of vertical bores each having an open upper end opening into the processing space, and the shanks of the substrate support rods are vertically movably inserted in the bores, respectively, the head of each substrate support rod is sized such that the head is unable to pass through the bore of the vessel body, and the heads of the substrate support rods are configured to close the open upper ends of the bores when the substrate support rods are held at the first vertical position.

Preferably, the head of each substrate support rod is provided with an elastic sealing member that is brought into contact with a part, around the open upper end of the bore, of the vessel body to prevent the processing fluid from flowing from the processing fluid into the bore when the substrate support rod is held at the first vertical position. In this case, preferably, an upper surface of the vessel body is provided with recesses adapted to receive the heads of the substrate support rods held at the first vertical position, respectively, and the bores of the vessel body extend downward from the bottom surfaces of the recesses, respectively, and the elastic sealing members arranged so that they are brought into contact with the bottom surfaces of the recesses, respectively.

Alternatively, the substrate processing vessel may be configured so that the head of each of the substrate support rods has an outer circumference tapering downward, and an inner circumference of each of the bores adjacent to an upper end portion of each of the bores has a shape complementary to the tapered outer circumference of the head of each of the substrate support rods, whereby each of the outer circumferences and each of the inner circumferences are in close contact with each other to form a seal that prevents a processing fluid from flowing from the processing space to each of the bores when the substrate support rod is held at the first vertical position.

The substrate processing vessel may further include a plurality of substrate support members arranged on the vessel body to support the substrate from below the same. In this case, substrate support surfaces of the substrate support members are at a height higher than that of substrate support surfaces of the heads of the substrate support rods at the first vertical position, whereby the substrate is supported by the substrate support members without being supported by the substrate support rods when the substrate support rods are at the first vertical position.

The driving device may include arms respectively connected to the shanks of the plurality of substrate support rods projecting downward from lower ends of the bores of the vessel body, the arm being arranged under a bottom surface of the vessel body; and an actuator adapted to move the arms vertically.

In this case, preferably, the substrate processing vessel further includes bellows respectively surrounding the shanks of the plurality of substrate support rods projecting down from the lower ends of the bores of the vessel body, wherein each of the bellows has an upper end hermetically connected to a part, around the lower end of the bore, of the vessel body, and a lower end hermetically connected to the arm.

In order to prevent troubles attributable to the malfunction of the actuator, an arm locking mechanism having a stopper adapted to separatably engage with the arm to lock the arm is may be provided.

The substrate processing vessel may be provided with an actuator adapted to move the cover vertically. In this case, a cover locking mechanism having a stopper adapted to separatably engage with the cover or a member fixed to the cover to lock the cover may be provided.

In one preferred embodiment, the substrate processing vessel has a sealing part for preventing leakage of the processing fluid from the processing space. Preferably, the processing vessel has a means for detecting leakage of the processing fluid through the sealing part. The means includes a sealed space defined on a side of the sealing part opposite to a processing-space side of the sealing part, a suction line connected to the sealed space, and a pressure gage placed in the suction line. According to this structure, when leakage of the processing fluid through the sealing part occurs, the pressure in the sealed space is changed, and the change in the pressure is detected by the pressure gauge. Thus, the leakage can be detected.

The sealed space may be the bore of the processing vessel receiving the shank of the substrate support rod. In one preferred embodiment, a joint of the vessel body and the cover is sealed by a first sealing member and a second sealing member disposed on an outer side of the first sealing member. In this case, the sealed space may be a space defined by the first and the second sealing members.

An ozone process line provided with an ozone killer may be connected to the suction line. In this case, if the processing fluid contains ozone, the creation of a toxic atmosphere around the substrate processing vessel due to the leakage of the processing fluid can be prevented.

The driving device for the substrate support rods of the substrate processing apparatus may include a piston connected to the substrate support rods, a cylinder surrounding the piston, and a working fluid supply system adapted to supply a working fluid to the cylinder.

The substrate processing vessel may further include an actuator adapted to move the cover vertically, and springs pushing the substrate support rods upward. In this case, the cover is provided with a pressing member adapted to come into contact with the heads of the substrate support rods to depress the substrate support rods against resilience of the springs when the cover is lowered. In this case, the driving device includes the springs, the actuator and the pressing member.

The substrate processing vessel may further include a vessel locking mechanism adapted to force the vessel body and the cover to closely join together and prevent separation of the cover from the vessel body, when the cover contacts the vessel body.

### BRIEF DESCRIPTION OF THE DRAWINGS

FIG. 1 is a schematic plan view of a resist removing system;

FIG. 2 is a schematic front elevation of the resist removing system shown in FIG. 1;

FIG. 3 is a schematic rear view of the resist removing system shown in FIG. 1;

FIG. 4 is a schematic sectional view of a substrate processing vessel in one embodiment according to the present invention included in a resist water-solubilizing unit included in the resist removing system shown in FIG. 1 in a state where a cover and a substrate support rods are at their lower positions;

FIG. 5 is a schematic sectional view of the substrate processing vessel shown in FIG. 4 in a state where the cover and the substrate support rods are at their upper positions;

FIG. 6 is an enlarged sectional view of a peripheral part of the substrate processing vessel shown in FIG. 4;

FIG. 7 is a schematic plan view of a locking mechanism combined with the substrate processing vessel shown in FIG. 4;

FIG. 8 is a vies of assistance in explaining the movement of pressure rollers included in the locking mechanism shown in FIG. 7;

FIG. 9 is a schematic sectional view of a substrate processing vessel in another embodiment according to the present invention applicable to the resist water-solubilizing unit included in the resist removing system shown in FIG. 1;

FIG. 10 is a schematic sectional view of a substrate processing vessel in another embodiment according to the present invention applicable to the resist water-solubilizing unit of the resist removing system shown in FIG. 1;

FIG. 11 is a schematic sectional view of a substrate processing vessel in another embodiment according to the present invention applicable to the resist water-solubilizing unit included in the resist removing system shown in FIG. 1;

FIG. 12 is a schematic sectional view of a substrate processing vessel in another embodiment according to the present invention applicable to the resist water-solubilizing unit included in the resist removing system shown in FIG. 1, taken on the line XII-XII in FIG. 13;

FIG. 13 is a plan view of a vessel body included in the substrate processing vessel shown in FIG. 12, taken in the direction of the arrow XIII;

FIG. 14 is a sectional view of the vessel body and the cover taken on the line XVI-XVI in FIG. 13; and

FIG. 15 is a schematic sectional view of a conventional substrate processing vessel.

### DESCRIPTION OF THE PREFERRED EMBODIMENTS

Preferred embodiments of the present invention will be described with reference to the accompanying drawings. The present invention will be described as applied to a resist removing system (substrate processing system) that carries out a process of water-solubilizing a resist film formed on a surface of a wafer W with a processing gas containing steam (deionized water vapor) and ozone (O₃) (hereinafter referred to as “resist water-solubilizing process”), and a cleaning process of removing the resist film processed by the resist water-solubilizing process by washing the wafer W with water and cleaning the wafer W after the resist film has been removed.

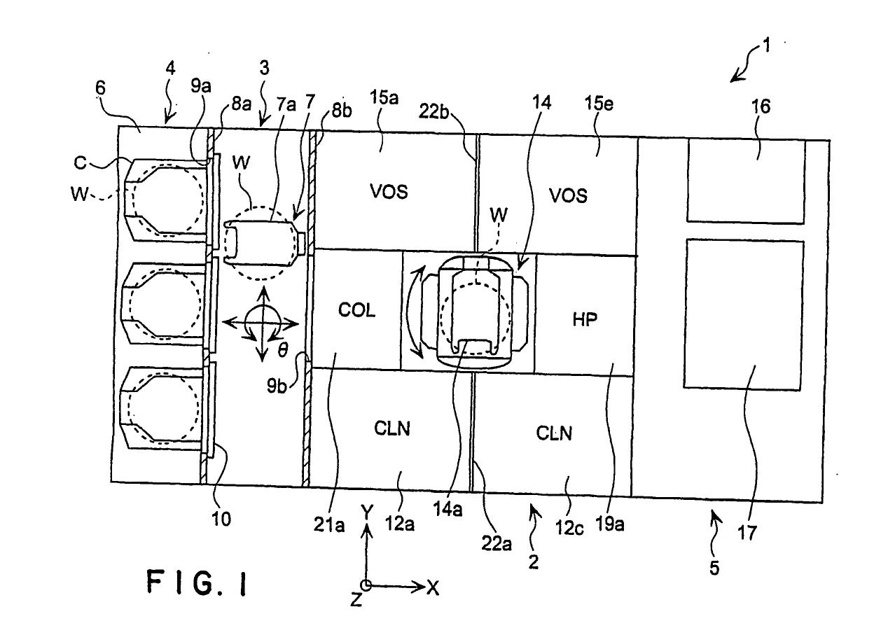

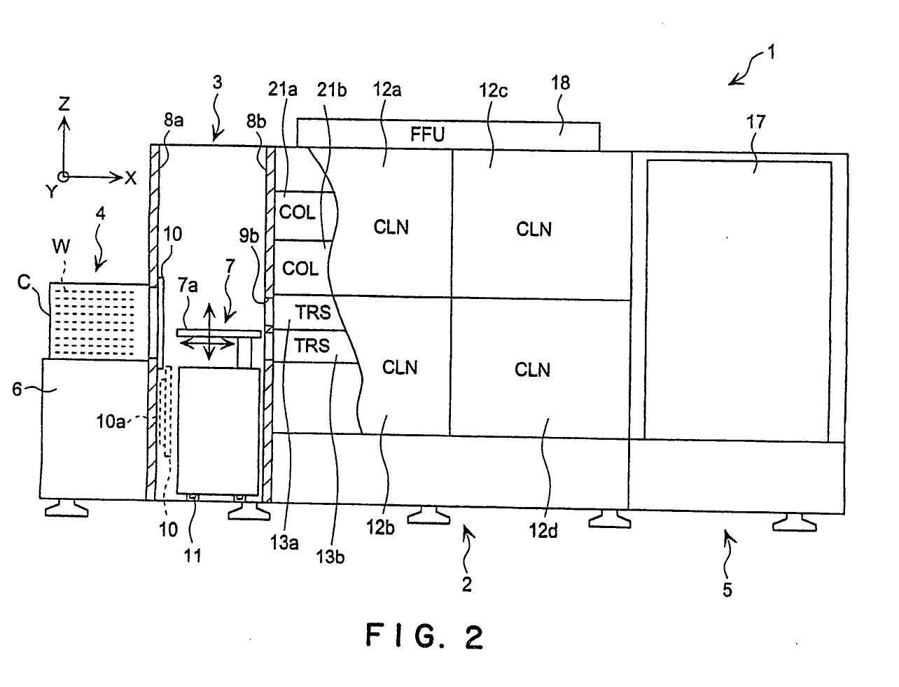

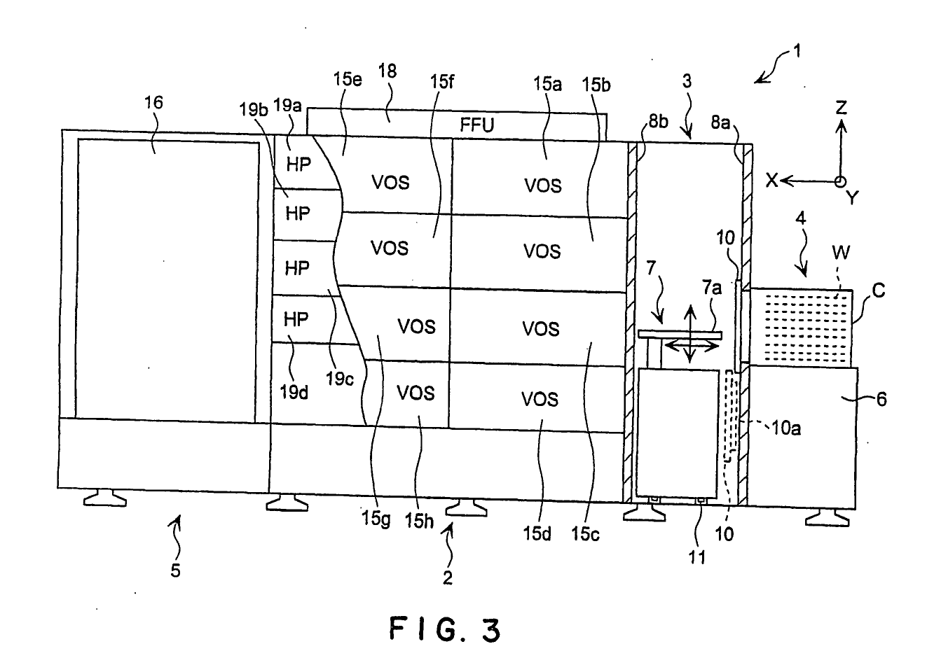

FIG. 1 is a schematic plan view of a resist removing system 1, FIG. 2 is a front view of the resist removing system 1 and FIG. 3 is a rear view of the resist removing system 1. The resist removing system 1 has a processing station 2, a conveying station 3, a carrier station 4 and a chemical station 5. A carrier holding wafers W is delivered to the carrier station 4 from another processing system or the like, and a carrier holding processed wafers W processed by a predetermined process by the resist removing system 1 is sent out from the carrier station 4 to another processing system. The processing station 2 has a plurality of processing units for processing wafers W by a resist water-solubilizing process, a resist removing process succeeding the resist water-solubilizing process, and a cleaning and drying process. The conveying station 3 is provided with a conveyer for carrying a wafer between the processing station 2 and the carrier station 4. The chemical station 5 prepares and stores chemical liquids and gases to be used by the processing station 2.

Wafers W are held in a substantially horizontal position and are vertically arranged at regular intervals in a carrier C. The wafer W is taken out from and put in the carrier C through an opening formed in one side of the carrier C and covered with a detachable lid 10a, not shown in FIG. 1. In FIGS. 2 and 3, the lid 10a is removed from the carrier C.

As shown in FIG. 1, the carrier station 4 is provided with a table 6 capable of supporting three carriers C thereon while the carriers C are aligned in Y-direction in FIG. 1. The carrier C is placed on the table 6 with the side surface provided with the lid facing a partitioning wall 8a arranged between the conveying station 3 and the carrier station 4. Windows 9a are formed in the partitioning wall 8a at positions corresponding to locations at which the carriers C are to be placed on the table 6. Shutters 10 are installed at positions respectively corresponding to the windows 9a on the side of the conveying station 3 to close the windows. Each of the shutters 10 is provided with a gripper, not shown, capable of gripping the lid 10a of the carrier C. As shown in FIGS. 2 and 3, the gripper removes the lid 10a from the carrier C and carries the lid 10a into the conveying station 3.

A wafer conveyer 7 installed in the conveying station 3 is provided with a wafer pickup device 7a for holding a wafer W. The wafer conveyer 7 is capable of traveling in Y-direction along guide rails 11 (see FIGS. 2 and 3) extending in Y-direction. The wafer pickup device 7a is horizontally movable, vertically movable along Z-directions and turnable in X-Y plane (θ-directions).

When the shutter 10 is opened so that the interior of the carrier C communicates with the conveying station 3 through the window 9a, the wafer pickup device 7a is able to access all the wafers W held in the carrier C. Thus, the wafer W at a desired height in the carrier C can be taken out of the carrier C and the wafer W can be delivered to an optional position in the carrier C.

The processing station 2 has two wafer holding units (TRS) 13a and 13b on the side of the conveying station 3. The wafer holding unit 13b holds an unprocessed wafer W temporarily when the unprocessed wafer W is carried from the conveying station 3 to the processing station 2. The wafer holding unit 13a holds a processed wafer W temporarily when the processed wafer W is returned from the processing station 2 to the conveying station 3. A filter fan unit (FFU) 18 supplies clean air into the processing station 2 in a down-flow mode. Therefore, the contamination of the processed wafer W held in the upper wafer holding unit 13a can be suppressed.

A partitioning wall 8b separating the conveying station 3 and the processing station 2 is provided with windows 9b, which are arranged at locations corresponding respectively to the wafer holding units 13a and 13b. The wafer pickup device 7a is able to access the wafer holding units 13a and 13b through the windows 9a. The wafer pickup device 7a is able to carry the wafer W between the carrier C and each of the wafer holding units 13a and 13b.

The processing station 2 is provided with eight resist water-solubilizing units (VOS) 15a to 15h, which perform a process for rendering a resist film formed on a wafer W water-soluble. The eight resist water-solubilizing units 15a to 15h are installed in a back part of the resist removing system 1 in two columns and four levels. The processing station 2 is provided also with four cleaning units (CLN) 12a to 12d for removing a water-soluble resist film from a wafer W processed by any one of the resist water-solubilizing units 15a to 15h. The cleaning units 12a to 12d are installed in a front part of the resist removing system 1 in two columns and two levels. A main wafer conveyer 14 is installed in central part of the processing station 2. The main wafer conveyer 14 carries a wafer W in the processing station 2.

Hot plate units (HPs) 19a to 19d for heating a wafer W processed by any one of the cleaning units 12a to 12d to dry the wafer W are disposed opposite to the wafer holding units 13a and 13b with respect to the main wafer conveyer 14. The hot plate units 19a to 19d are stacked in four levels. Cooling plate units (COL) 21a and 21b for cooling a dried wafer W are stacked above the wafer holding unit 13a. The wafer holding unit 13a has the function of a cooling plate unit. The filter fan unit (FFU) 18 for sending clean air into the processing station 2 is installed in an upper part of the processing station 2.

The main wafer conveyer 14 has a wafer carrying arm 14a for carrying a wafer W. The main wafer conveyer 14 has a body capable of turning abut an axis extending in Z-directions. The wafer carrying arm 14a is movable in horizontal directions and in Z-directions. The main wafer conveyer 14 is able to access any units of the processing station 2 and carries a wafer W from one to another unit of the processing station 2.

The resist water-solubilizing units 15a to 15d and the resist water-solubilizing units 15e to 15h are substantially symmetrical in configuration with respect to a partitioning wall 22b. Each of the resist water-solubilizing units 15a to 15d has a hermetic processing vessel capable of holding a wafer W in a horizontal position therein. A processing gas containing steam and ozone is supplied into the processing vessel, thereby a resist film formed on a surface of a wafer W is changed into a easily-removable, water-soluble film.

The cleaning units 12a and 12b are substantially symmetrical in configuration with respect to a partitioning wall 22a, which simplifies the construction of the main wafer conveyer 14 and facilitates the operation of the main wafer conveyer 14 to access the cleaning units 12a to 12d. Each of the cleaning units 12a to 12d has a spin chuck capable of holding a wafer W and of turning, a cup surrounding the spin chuck, a cleaning liquid jetting nozzle for jetting a cleaning liquid, such as pure water or an organic solvent, onto the surface of a wafer W held by the spin chuck, and a gas jetting nozzle for jetting a dry gas onto the surface of a wafer W. The cleaning units 12a to 12d are conventional ones and hence the further description thereof will be omitted.

The chemical station 5 has a processing gas supply unit 16 and a cleaning liquid supply unit 17. The processing gas supply unit 16 produces a processing gas containing steam and ozone and supplies the processing gas to the resist water-solubilizing units 15a to 15h. The cleaning liquid supply unit 17 stores a cleaning liquid to be used by the cleaning units 12a to 12d and supplies the same to the cleaning units 12a to 12d. The processing gas supply unit 16 is provided with an ozone generator, not shown, for converting oxygen into ozone, a steam generator, not shown, for converting deionized water into steam, and a mixer, not shown, for mixing a mixed gas of ozone and nitrogen, and steam to generate a processing fluid. The processing gas supply unit 16 is provided with a nitrogen gas supply line, not shown. Nitrogen gas is used for diluting ozone and purging the processing vessels.

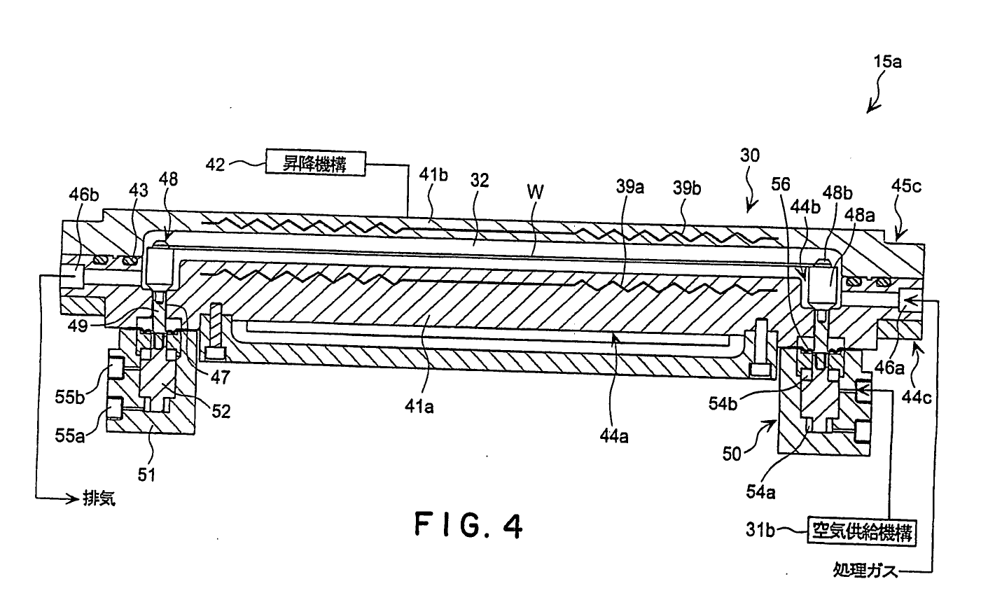

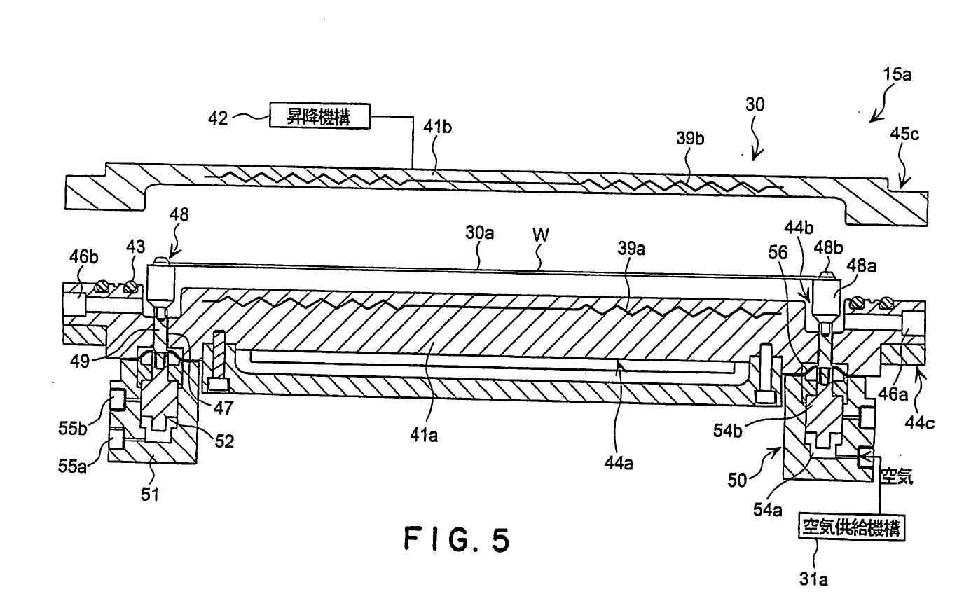

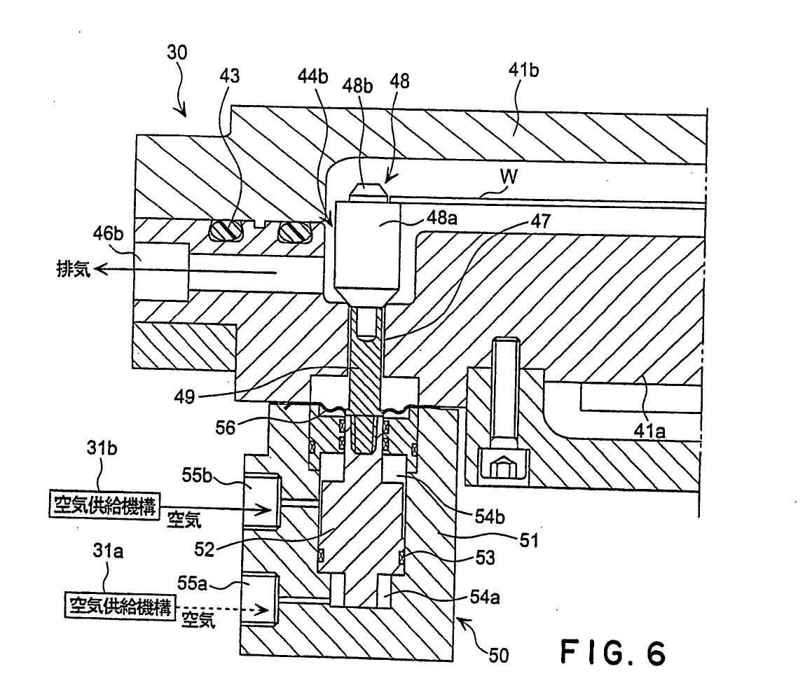

The resist water-solubilizing unit 15a will be described. The resist water-solubilizing unit 15a has a hermetic processing vessel arranged in a case, not shown, and adapted to hold a wafer W therein. FIGS. 4 and 5 show the processing vessel 30 according to the present invention in schematic sectional views. FIG. 6 is an enlarged sectional view of the peripheral portion of the processing vessel 30.

The processing vessel 30 includes a vessel body 41a fixedly installed inside the case, not shown, of the resist water-solubilizing unit 15a, and a cover 41b covering the upper surface of the vessel body 41a. The cover 41b can be moved vertically by a lifting mechanism 42, such as a pneumatic cylinder actuator, attached to a frame or an upper wall, not shown, of the case. In FIGS. 4 and 6, the cover 41b is closely joined to the vessel body 41a. In FIG. 5, the cover 41b is raised apart from the vessel body 41a.

O-rings 43 are placed on the upper surface of a peripheral part 44c of the vessel body 41a. The lower surface of a peripheral part 45c of the cover 41b is substantially flat. The cover 41b is lowered so as to compress the O-rings 43 to seal the joint of the lower surface of the peripheral part 45c of the cover 41b and the upper surface of the peripheral part 44c of the vessel body 41a. Thus, a sealed processing space 32 is formed in the processing vessel 30.

Formed in the peripheral part 44c of the vessel body 41a are a gas supply port 46a for supplying processing gas containing steam and ozone into the processing space 32, and a gas discharge port 46b for discharging the processing gas used in the processing space 32. Various gases, such as nitrogen gas or a mixed gas of nitrogen gas and ozone, which are to be used for purging the processing space 32 before and after supplying the processing gas into the processing space 32, can be supplied through the gas supply port 46a.

The cover 41b can be closely joined to the vessel body 41a by a pressing force generated by the lifting mechanism 42. Preferably, the processing vessel 30 is provided with a locking mechanism 35 capable of firmly joining the vessel body 41a and the cover 41b together to ensure the close connection of the vessel body 41a and the cover 41b and to cope with troubles due to the unexpected, temporary malfunction of the lifting mechanism 42.

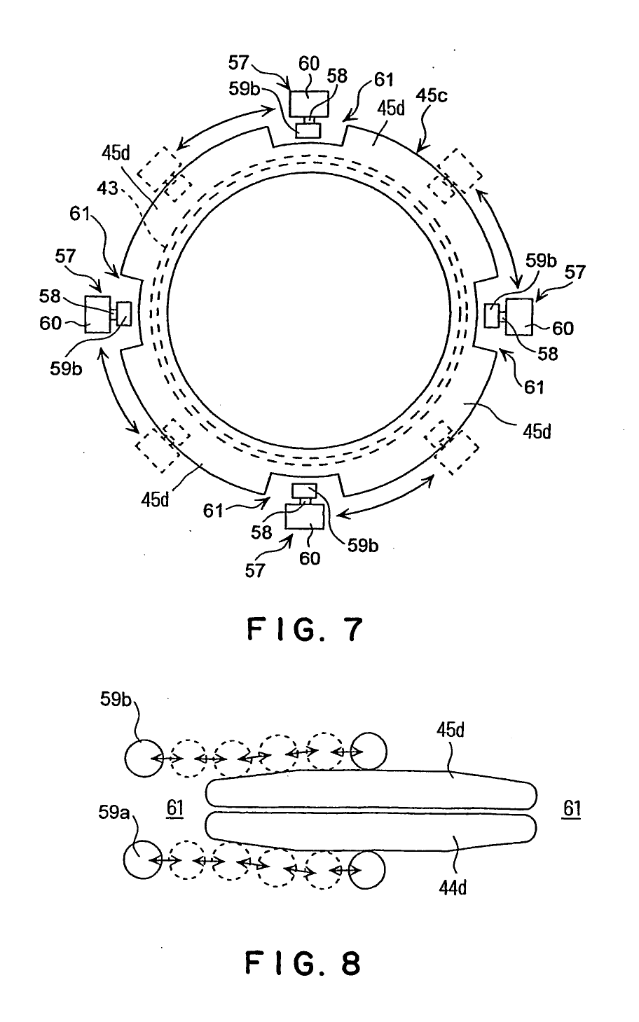

FIG. 7 is a top plan view of the processing vessel 30 provided with the locking mechanism 35, as viewed from above the cover 41a. The peripheral part 45c of the cover 41b is provided with four cutouts 61, thereby four circular flanges 45d are defined at the peripheral part 45c of the cover 41b. The peripheral part 44c of the vessel body 41a is provided with four cutouts 61 respectively corresponding to the cutouts 61 of the cover 41b, thereby four circular flanges 44d are defined at the peripheral part 44c of the vessel body 41a. The flanges 45d of the cover 41b respectively overlap the flanges 44d of the vessel body 41a, as viewed from the above. The locking mechanism 35 has four clamping devices 57 synchronously movable along the circumference of the cover 41b. Each of the clamping devices 57 includes clamping rollers 59a and 59b supported for rotation on shafts 58, respectively, and roller holding members 60 holding the shafts 58.

FIG. 8 is a schematic side elevation of the respective flanges 44d and 45d of the vessel body 41a and the cover 41b and the clamping rollers 59a and 59b. The cover 41a can be freely moved in vertical directions while the clamping devices 57 are positioned in the cutouts 61, respectively. When the four clamping devices 57 are turned simultaneously along the circumference of the cover 41b through an angle of 45° about the center axis of the cover 41b, the clamping rollers 59a roll along slopes formed on the upper surfaces of the flanges 45d of the cover 41b, respectively, and the clamping rollers 59b roll along slopes formed on the lower surfaces of the flanges 44d of the vessel body 41a, respectively. The distance between the corresponding clamping rollers 59a and 59b is shorter than the distance between the lower surface of the flange 44d and the upper surface of the flange 45. When the clamping rollers 59a and 59b are at the respective middles of the flanges 44d and 45d, the clamping rollers 59a and 59b clamp the flanges 45d and 45d firmly. Thus, the cover 41b is pressed firmly against the vessel body 41a.

The shafts 58 may be vertically movably supported with springs on the roller holding member 60 to enable the adjustment of pressure exerted by the clamping rollers 59a and 59b. The number of the cutouts 61 is not limited to four as shown in FIG. 7. Preferably, at least three hollows 61 are arranged at equal angular intervals.

A disk-shaped stage 44a is formed in a central part of the vessel body 41a. An annular groove 44b is formed between the stage 44a and the peripheral part 44c. Three through holes 47 are formed at the annular groove 44b. The through holes 47 extend downward from the bottom surface of the annular groove 44b through the vessel body 41a. A lower part of each of the through holes 47 has a diameter greater than that of an upper part of each of the through holes 47.

A substrate support rod 49, which is provided at the tip thereof with a support member (head) 48 for supporting a wafer W thereon, is arranged in each of the through holes 47. The support member 48 may be formed separately from the rod portion as shown in the drawings, or may be formed integrally in a single member. Rod lifting mechanisms 50 are attached to the lower surface of the vessel body 41a.

The support member 48 has a body 48a having a top surface for supporting a wafer W thereon and a guide 48b formed on the top surface of the body 48a. The guides 48b restrain a wafer W supported on the bodies 48a from horizontal movement. Each body 48a has a downward tapered lower part having the shape of a frustum. An upper end part of the through hole 47 has the shape of a frustum complementary to the shape of the lower part of the body 48a (see FIG. 6). When the rod lifting mechanism 50 is operated so as to press the support member 48 against the entrance portion of the through hole 47, the through hole 47 is closed in an airtight fashion by the support member 48. Thus the processing gas supplied into the processing space 32 in the processing vessel 30 is unable to leak outside from the processing vessel 30 through the through holes 47.

Referring to FIG. 6, the rod lifting mechanism 50 includes a cylinder 51 having a cylindrical internal space, and a lifting rod 52 fitted in the cylinder 51; The upper end of the lifting rod 52 is connected to the lower end of the substrate support rod 49. The lifting rod 52 is provided at the middle portion thereof with an expanded part (i.e., a piston) of a larger diameter. The internal space of the cylinder 51 is divided into an upper chamber 54b and a lower chamber 54a by the expanded part of the lifting rod 52. A sealing ring 53 is fitted in an annular groove formed in the circumference of the expanded part of the lifting rod 52.

The cylinder 51 is provided with a first air passage 55a connected to the lower chamber 54a, to which an air supply systems 31a is connected by a pipe. A second air passage 55b is connected to the upper chamber 54b, to which an air supply systems 31b is connected by a pipe.

When air is supplied through the first air passage 55a into the lower chamber 54a, the lifting rod 52 elevates. When air is supplied through the second air passage 55b into the upper chamber 54b, the lifting rod 52 lowers. The substrate support rod 49 and the support member 48 move vertically as the lifting rod 52 moves vertically. An enlarged part of a larger diameter is arranged at the lower end of the support rod 49. When the enlarged part of the support rod 49 comes into contact to the exit portion of the smaller diameter part of the through hole 47, the support rod 49 can no longer elevate, thereby the upper limit position of the support member 48 is determined.

Referring to FIG. 5, when the substrate support rod 49 and the support member 48 are raised, the vertical distance between the wafer support surface of the support member 48 and the upper surface of the stage 44a increases. Consequently, the wafer carrying arm 14a, not shown in FIG. 5, is able to transfer a wafer W to and from the support member 48 without colliding with the vessel body 41a. As shown in FIGS. 4 and 6, when the lifting rod 53 is lowered, the support member 48 closes the upper entrance of the through hole 47, while the wafer W is positioned in the vicinity of the stage 44a and is supported on the support member 48.

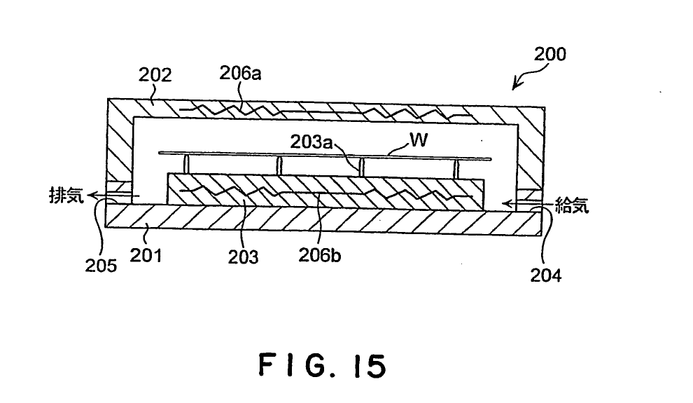

The processing vessel 30 does not need any member corresponding to the long substrate support pins 203a, permanently projecting into the processing space, of the conventional processing vessel 200 shown in FIG. 15. Therefore, the processing vessel 30 can be formed in a low profile and a small content volume. Furthermore, when the support members 48 are lowered, the support members 48 is located in the annular groove 44b of the vessel body 41a and a wafer W supported on the support members 48 is positioned close to the stage 44a. Thus, the content volume of the processing space 32 can be further reduced. The processing space 32 having a small content volume reduces the necessary amount of the processing gas.

As mentioned above, since the lowered support members 48 close the entrance portions of the through holes 47, the processing gas is prevented from leaking outside from the processing vessel 30 through the through holes 47. However, the lower end of each through hole 47 is closed by a circular diaphragm 56 to cope with an unexpected trouble due to the adhesion of foreign matters to the support members 48 or the temporary malfunction of the rod lifting mechanisms 50. An inner peripheral part of the diaphragm 56 is hermetically connected to the support rod 49, and an outer peripheral part of the diaphragm 56 is held between a part, around the lower end of the through hole 47, in the lower surface of the processing vessel 30 and the upper surface of the cylinder 51. Preferably, the diaphragm 56 is formed of a corrosion-resistant fluorocarbon resin, such as PTFE.

A heater 39a for heating a wafer W is embedded in the stage 44a of the vessel body 41a. A wafer W can be quickly heated at a desired temperature because the wafer W is supported near the stage 44a on the lowered support members 48 while the wafer W is processed. The wafer W can be highly uniformly heated. Thus throughput is improved and the wafers W can be processed in high quality. The cover 41b is provided with a heater 39b. The heater 39b of the cover 41b enables quicker and more uniform heating of a wafer W. The heaters 39a and 39b are not shown in FIG. 6.

A series of process steps to be carried out by the resist removing system 1 will be described. A carrier C holding wafers W processed by an etching process is placed on the table 6 by an operator or an automatic carrying machine. The wafers W are coated with a resist film, which has been used as an etching mask in the etching process. The shutter 10 is lowered to open the window 9a and the lid 10a is removed from the carrier C. Subsequently, the wafer pickup device 7a conveys a wafer W at a certain position in the carrier C to the wafer holding unit 13b.

Then, the wafer carrying arm 14a carries the wafer W from the wafer holding unit 13b to the resist water-solubilizing unit 15a (or any one of the resist water-solubilizing units 15b to 15h). The carrying-in of the wafer W to the resist water-solubilizing unit 15a is performed in the following manner. The cover 41b of the processing vessel 30 is separated from the vessel body 41a and is withdrawn to a position above the vessel body 41a. Thereafter, the rod lifting mechanisms 50 are operated to raise the support members 48. Then, the wafer carrying arm 14a holding the wafer W brings the wafer W to a position above the support members 48, moves down, and withdraws horizontally from the space between the vessel body 41a and the cover 41b. Thus, the wafer W is transferred from the wafer carrying arm 14a to the support members 48.

After the wafer carrying arm 14a has been withdrawn from the resist water-solubilizing unit 15a, the rod lifting mechanisms 50 are operated to lower the support members 48 to place the wafer W at a predetermined processing position and to close the through holes 47 with the bodies 48a of the support members 48, respectively. Subsequently, the cover 41b is lowered and is brought into close contact with the vessel body 41a. Then, the locking mechanism 35 is operated to join the vessel body 41a and the cover 41b firmly together in order to hermetically close the processing vessel 30.

The heaters 39a and 39b of the vessel body 41a and the cover 41b are energized to keep the central parts of the stage 44a of the vessel body 41a and the cover 41b at predetermined temperatures, respectively. For example, the stage 44a is heated at 100° C., while the cover 41b is heated at 110° C. Thus, the condensation of steam is prevented when the processing gas containing steam and ozone is supplied into the substrate processing vessel 30. The density of steam in the substrate processing vessel 30 is higher in the vicinity of the stage 44a than in the vicinity of the cover 41b. Thus, steam can be efficiently applied to the wafer W.

If the difference between the respective temperatures of the stage 44a and the cover 41b is excessively large, steam tends to condense on the stage 44a and the wafer W. If the difference between the respective temperatures of the stage 44a and the cover 41b is small, there will be no difference in steam density between a space over the wafer W and a space under the wafer W. Therefore, the temperature difference between the stage 44a and the cover 41b is between 5° C. and 15° C., preferably, 10° C.

After the stage 44a and the cover 41 have been stabilized respectively at the predetermined temperatures, and temperature distribution on the surface of the wafer W has become uniform, a mixed gas of ozone and nitrogen is supplied through the gas supply port 46a into the processing vessel 30 (the processing space 32) to purge the processing vessel 30 and to keep the pressure in the processing vessel 30 at a predetermined positive pressure of, for example a gage pressure of 0.2 MPa. A mixed processing fluid (i.e., a processing gas), namely, a mixed gas of the mixed gas of ozone and nitrogen, and steam, is supplied into the processing vessel 30. The processing gas oxidizes the resist film formed on the wafer W to convert the resist film into water-soluble. During this process step, the supply rate at which the processing gas is supplied through the gas supply port 46a and the discharge rate at which the processing gas is discharged through the gas discharge port 46b are properly regulated to keep the interior of the processing vessel 30 at a predetermined positive pressure. Thus, time necessary for water-solubilizing the resist film can be reduced and throughput can be improved.

Since the through holes 47 are closed by the support members 48 while the wafer W is being processed, the processing gas is unable to leak outside from the processing vessel 30. Even if the processing gas should flow through the through holes 47 by some rare accident, the diaphragms 56 prevents the processing gas from leaking outside from the processing vessel 30. Thus, the devices and the processing units installed in the processing station 2 are prevented from the damaging effect of the processing gas.

After the completion of the resist water-solubilizing process, the supply of the processing gas is stopped. Then, nitrogen gas is supplied by the processing gas supply device 16 into the processing vessel 30 to purge the processing vessel 30 with the nitrogen gas. After the completion of the purging process with the nitrogen gas, it is confirmed that the internal pressure of the substrate processing vessel 30 is equal to the external atmospheric pressure. It is possible that the processing vessel 30 is damaged if the substrate processing vessel 30 is opened when the internal pressure of the substrate processing vessel 30 is higher than the atmospheric pressure. After the confirmation of the internal pressure of the processing vessel 30, the locking mechanism 35 is operated to unlock the processing vessel 30, and then the cover 41b is raised. Subsequently, the rod lifting mechanisms 50 are operated to raise the support members 48. Then, the wafer carrying arm 14a advances into a space under the wafer W, and thereafter rises to lift up the wafer W from the support members 48.

The resist water-solubilizing process performed by the resist water-solubilizing unit 15a converts the resist film into water-soluble one but does not remove the resist film from the wafer W. Thus, the wafer W is delivered to any one of the cleaning units 12a to 12d and is subjected to a resist removing process using a cleaning liquid for removing the water-soluble resist film

The wafer W cleaned by one of the cleaning units 12a to 12d is delivered to any one of the hot plate units 19a to 19d to be heated and dried. Then, the wafer W is delivered to one of the cooling plate units 21a and 21b to be cooled. The wafer W cooled at a predetermined temperature is conveyed to the wafer holding unit 13a by the main wafer conveyer 14, and then is conveyed to a predetermined position in the carrier C.

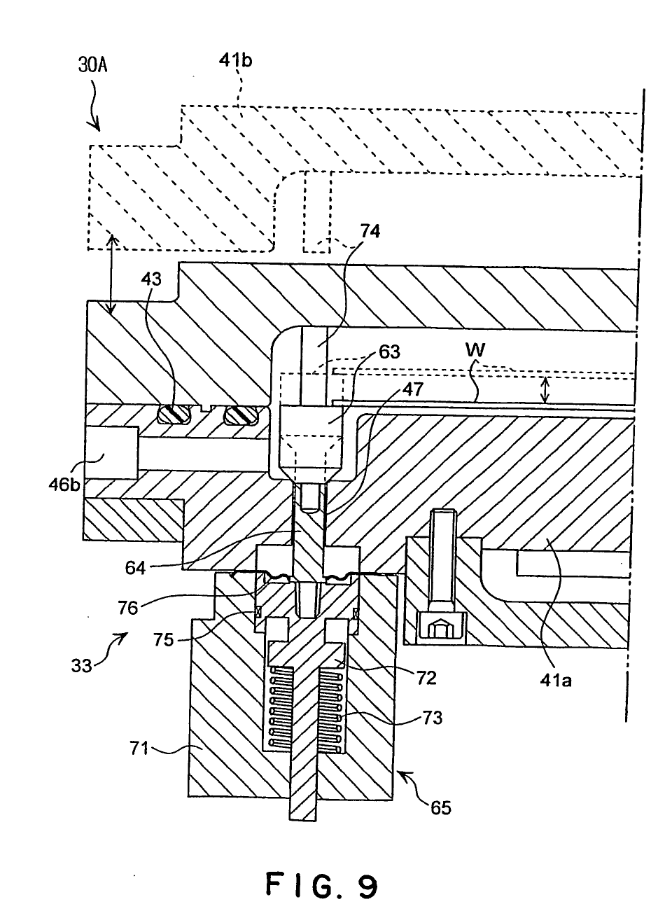

A processing vessel 30A in another embodiment applicable to the resist water-solubilizing unit 15a will be described. FIG. 9 shows the processing vessel 30A in a schematic sectional view. The processing vessel 30A has a vessel body 41a, which is the same in construction as the vessel body 41a of the processing vessel 30. The processing vessel 30A has substrate support mechanisms 33. Each substrate support mechanism 33 includes a substrate support rod 64 inserted in a through hole 47 and having a support member (head) 63 at the upper end thereof that supports the peripheral part of a wafer W thereon, and a biasing mechanism 65 for biasing the support rod 64 upward.

The support member 63 is the same in construction as the body 48a of the support member 48. When the support member 63 is pushed toward the through hole 47 by a pressing member 74 (described later), the support member 63 closes the entrance portion of the through hole 47 in an airtight fashion.

The biasing mechanism 65 includes a cylindrical member 71 having a cylindrical interior space, a lifting rod 72 arranged in the interior space, and a spring 73 biasing the lifting rod 72 upward. The cylindrical member 71 is attached to the lower surface of the vessel body 41a so as to cover the exit of the through hole 47. The lifting rod 72 is connected to the support rod 64. The lifting rod 72 is supported in the cylindrical member 71 by a bearing 75 so as to slide vertically in the cylindrical member 71.

A lower part of the lifting rod 72 is passed through the spring 73. The lifting rod 72 has an expanded part of a larger diameter, which has a lower surface in contact with the upper end of the spring 73. The spring 73 has a lower end seated on the bottom wall of the cylindrical member 71. The bottom wall of the cylindrical body 71 is provided with a through hole of a diameter slightly greater than the diameter of a lower end portion of the lifting rod 72 to guide the lifting rod 72.

When a cover 41b is withdrawn upward, the spring 73 urges the lifting rod 72 upward. However, as the expanded part is formed in the lower end portion of the support rod 64, the expanded part comes into contact with the exit portion of a small diameter part of the through hole 47, so that the support rod 64 can no longer move upward. Thus the upper limit position of the support member 63 is determined.

The pressing members 74 are attached to the inner surface of the cover 41b. When the cover 41b is lowered, the pressing members 74 come into contact with the support members 63, and lower the support members 63, the support rods 64 and the lifting rods 72 simultaneously, compressing the springs 73. In FIG. 9, continuous lines indicate a state where the cover 41b has been lowered and joined to the vessel body 41a, the support members 63 has been completely pushed downward by the pressing members 74 and the through holes 47 have been closed. As obvious from FIG. 9, the pressing members 74 in contact with the support members 73 serve as guides for restraining a wafer W from horizontal movement. In FIG. 9, doted lines indicate a state where the cover 41b has been moved away from the vessel body 41a and the support members 63 have been raised by the springs 73.

Advantageously, the biasing mechanisms 65 are simple in construction, do not need any mechanism corresponding to the air supply mechanisms needed by the rod lifting mechanisms 50 as previously described, and do not need any operations for controlling the biasing mechanisms 65.

The processing vessel 30A, similarly to the processing vessel 30 shown in FIGS. 4 to 6, is provided with diaphragms 76 for secondarily preventing the leakage of the processing gas through the through holes 47. The inner peripheral part of each diaphragm 76 is attached to the support rod 64 an airtight fashion, and the outer peripheral part held between a part, around the through hole 47, of the lower surface of the processing vessel 30 and the upper surface of the cylindrical member 71.

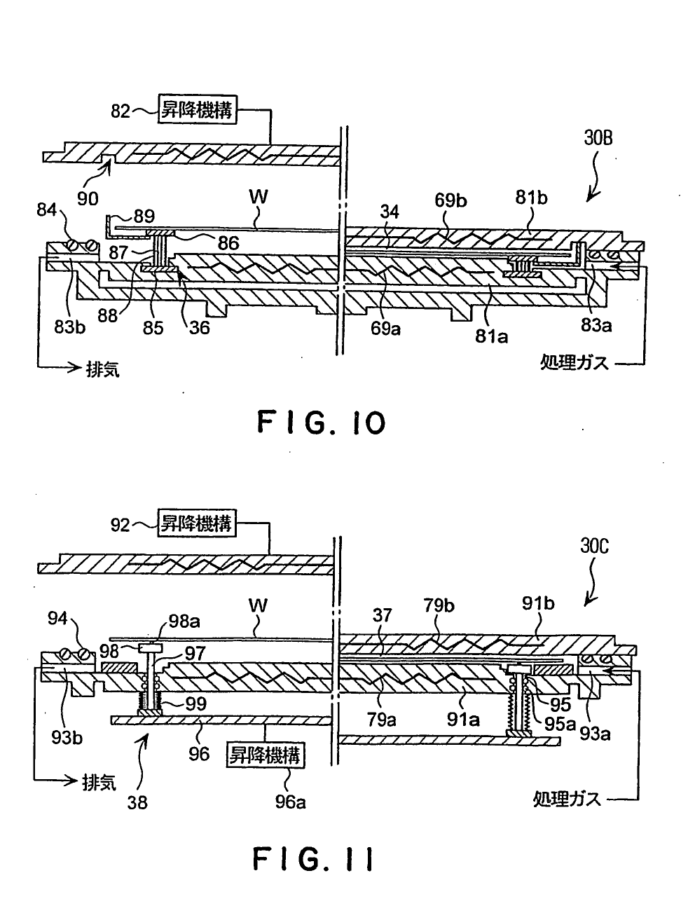

FIG. 10 shows a processing vessel 30B in another embodiment according to the present invention in a schematic sectional view. The processing vessel 30B has a vessel body 81a and a cover 81b. Heaters 69a and 69b for heating a wafer W are embedded in the vessel body 81a and the cover 81b, respectively. The cover 81b can be vertically moved by a lifting mechanism 82. The left half part of FIG. 10 shows a state where the cover 81b is separated from the vessel body 81a and is withdrawn upward, and the right half part of FIG. 10 shows a state where the cover 81b is closely joined to the vessel body 81a.

O-rings 84 are placed on the upper surface of a peripheral part of the vessel body 81a. A peripheral part of the cover 81b compresses the O-rings 84 to seal the joint of the cover 81b and the vessel body 81a when the cover 81b is lowered to form a sealed processing space 34 in the substrate processing vessel 30B. The vessel body 81a is provided with a gas supply port 83a through which a processing gas is supplied into the processing space 34, and a gas discharge port 83b through which the processing gas is discharged from the processing space 34.

Wafer support mechanisms 36 attached to the vessel body 81a support a wafer W in the substrate processing vessel 30B. Each wafer support mechanism 36 includes: a base 85 fixed to the vessel body 81a; a support plate 86 on which a wafer W is seated; and a telescopic, stretchable rod 87 having a lower end fixed to the base 85 and an upper end fixed to the support plate 86; a spring 88 surrounding the stretchable rod 87 and having a lower end connected to the base 85 and an upper end connected to the support plate 86; and an arm 89 having a substantially L-shaped cross section, attached to the support plate 86 and capable of being brought into contact with and of being separated from the cover 81b. The arm 89 extends radially outward under a wafer W supported on the support plate 86, is then bent to rise vertically, and extends to a position at a level above the upper surface of the wafer W.

Preferably, a pin having a small diameter projects from the upper surface of the support plate 86. The pin comes into contact with a part, having a small area, of the wafer W, which is effective in suppressing the contamination of the back surface of the wafer W. In a state where the cover 81b is withdrawn upward, the support plate 86 is raised and is held at a predetermined height by the resilience of the spring 88 (See the left half part of FIG. 10). In this state, a wafer W can be transferred between the wafer carrying arm 14a and the support plates 86.

When the cover 81b is lowered, the upper ends of the arms 89 are received in recesses 90 formed in the lower surface of the cover 81b, respectively, and the arms 89 are depressed by the cover 81b. Consequently, the support plates 86 connected to the arms 89 move downward, compressing the springs 88. The respective dimensions of the component members of each wafer support mechanism 36 are designed such that narrow gaps of about 1 mm is formed between the upper surface of the vessel body 81a and the back surface of a wafer W and between the lower surface of the vessel body 81a and the surface of the wafer W, respectively, when the cover 81b is joined to the vessel body 81a as shown in the right half part of FIG. 10. After the cover 81b has been joined to the vessel body 81a, a processing gas is supplied into the processing space 34 to subject a resist film formed on a wafer W to a resist water-solubilizing process.

If the springs 88 are self-supportable, the stretchable rods 87 may be omitted. Preferably, the component members of the wafer support mechanisms 36 are formed of materials resistant to the corrosive action of the processing gas. It is also preferable to coat the surfaces of those members with a material resistant to the corrosive action of the processing gas.

FIG. 11 shows a substrate processing vessel 30C in another embodiment according to the present invention in a schematic sectional view. The substrate processing vessel 30C has a vessel body 91a and a cover 91b. Heaters 79a and 79b for heating a wafer W are embedded in the vessel body 91a and the cover 91b, respectively. The cover 91b can be moved vertically by a lifting mechanism 92. A state where the cover 91b is raised to be separated from the vessel body 91a is shown in the left half part of FIG. 11, and a state where the cover 91b is joined closely to the vessel body 91a is shown in a right half part of FIG. 11.

O-rings 94 are placed on the upper surface of a peripheral part of the vessel body 91a. When the cover 91b is lowered, the lower surface of a peripheral part of the cover 91b compresses the O-rings 94 so that the vessel body 91a and the cover 91b are hermetically joined, thereby a sealed processing space 37 is formed in the processing vessel 30C. The vessel body 91a is provided with a gas supply port 93a for supplying a processing gas into the processing space 37, and a gas discharge port 93b for discharging the atmosphere in the processing space 37. A plurality of through holes 95 are formed in the bottom wall of the vessel body 91a.

In the substrate processing vessel 30B, a wafer lifting device 38 supports and vertically moves a wafer W. The wafer lifting device 38 includes a lifting plate 96 vertically moved by a lifting mechanism 96a, support plates 98 for supporting a wafer W thereon, support rods 97 connecting the support plates 98 to the lifting plate 96 and extending via through holes 95 formed in the vessel body 91a, support pins 98a projecting from the surfaces of the support plates 98, and bellows 99 for preventing a processing gas from leaking outside from the substrate processing vessel 30C through the through holes 95. Each of the bellows 99 surrounds the support rod 97 and has opposite ends hermetically connected to the lower surface of the vessel body 91a and the upper surface of the lifting plate 96, respectively.

Sealing rings 95a are placed in each through hole 95. The sealing rings 95a permits the smooth vertical movement of the support rod 97 and prevents the processing gas from leaking outside from the substrate processing vessel 30C through the through hole 95.

When the cover 91b is raised to be separated from the cover 91a, the lifting mechanism 96a is able to move the lifting plate 96 upward. Thus, the bellows 99 are forced to contract, and the support plates 98 are spaced a predetermined vertical distance apart from the vessel body 91a (See the left half part of FIG. 11). In this state, a wafer W can be transferred between the wafer carrying arm 14a to the support plates 98.

When the lifting mechanism 96a lowers the lifting plate 96 and the support plates 98, the cover 91b can be lowered and can be joined closely to the vessel body 91a. Thereby, a processing space 37 is formed, and a wafer W is held in the processing space 37 (See the right half part of FIG. 11). Then, the wafer W is heated and a processing gas is supplied into the processing space 37 to process a resist film formed on the wafer W by a resist water-solubilizing process.

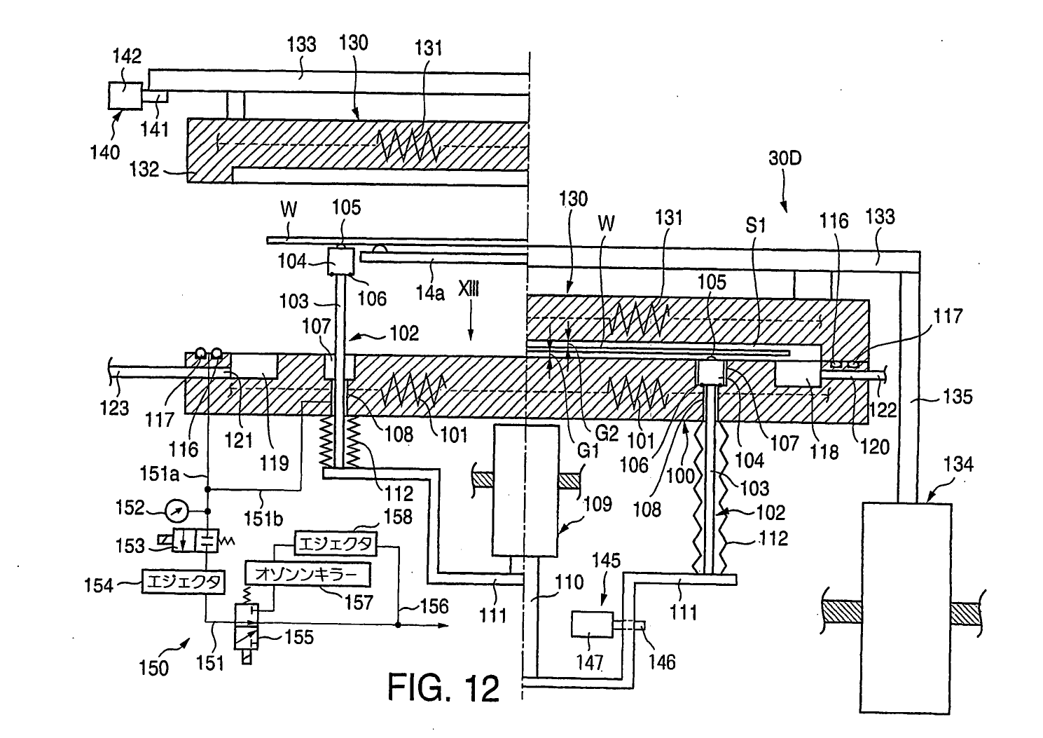

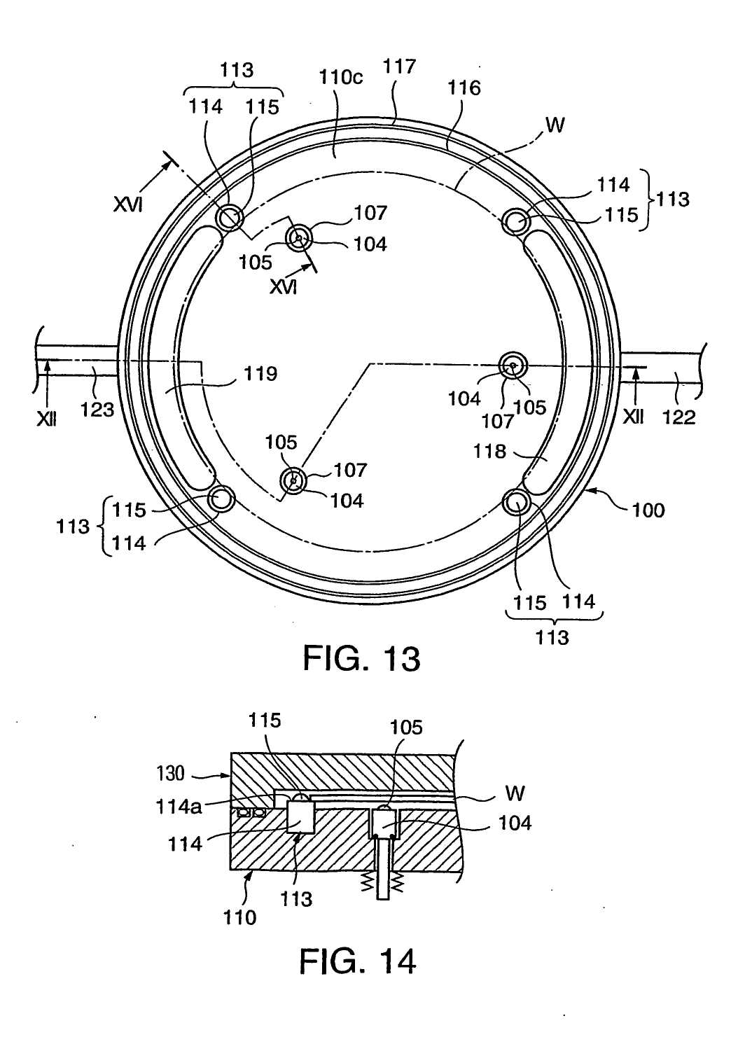

FIGS. 12 to 14 show a substrate processing vessel 30D in another embodiment according to the present invention. The substrate processing vessel 30D has a vessel body 100 fixedly attached to a box or a frame, not shown, included in the water-solubilizing unit, and a cover 130 adapted to cover the upper surface of the vessel body 100 to define a processing space S1 together with the vessel body 100.

The vessel body 100 is a substantially disk-shaped block provided with a built-in heater 101. Three substrate support rods 102 are arranged at equal angular intervals on a circle of a first diameter. Each substrate support rod 102 has a vertical, narrow, cylindrical shank 103 and a cylindrical head 104 coaxially connected to the upper end of the shank 103. The head has a diameter greater than that of the shank 103. A support pin 105 for supporting a wafer W thereon projects from a central part of the top surface of the head 104. An O-ring 106 is held on the lower surface of the head 104.

Each head 104 is formed of a stainless steel and is coated with a silica coating. The silica coating prevents corrosion of the stainless steel in an atmosphere of a processing fluid containing steam and ozone. Each support pin 105 is formed of a fluorinated resin, preferably, a polytetrafluoroethylene (PTFE), so that the support pin 105 may not elute matters detrimental to processing a wafer W when the support pin 105 is exposed to the atmosphere of the processing fluid.

Recesses 107 are formed in the upper surface of the vessel body 100. Each of the recesses 107 has a diameter slightly greater than that of the head 104, and a depth approximately equal to the height of the head 104. Through holes 108 of a diameter smaller than that of the head 104 and greater than that of the shank 103 are formed in the vessel body 100. Each of the through holes 108 has an upper end opening in the bottom surface of the recess 107 and a lower end opening in the bottom surface of the vessel body 100. The O-ring 106 may be placed on the bottom surface of each recess 107 instead of on the lower surface of the head 104. However, it is preferable to hold the O-ring 106 on the head 104 in view of extending the life of the O-ring 106 and improving the facility of maintenance.

A pneumatic cylinder actuator 109, namely, a linear actuator, is disposed under the vessel body 100. Rod lifting arms 111, which respectively extend toward the substrate support rods 102, are attached to the free end of a cylinder rod 110 of the pneumatic cylinder actuator 109. The lower ends of the shanks 103 of the substrate support rods 102 are fixed to the free ends of the arms 111, respectively. The substrate support rods 102 can be vertically moved between an upper position indicated in the left half part of FIG. 12 and a lower position indicated in the right half part of FIG. 12 by the pneumatic cylinder actuator 109. The shank 103 of each substrate support rod 102 is surrounded by a bellows 112. The bellows 112 has opposite ends closely attached to the bottom surface of the vessel body 100 and the upper surface of the rod lifting arm 111, respectively. The bellows 112 prevents the processing fluid from leaking outside from the substrate processing vessel 30D when an accident, such as the breakage of the O-ring 106, occurs.

Four support members 113 are disposed on the vessel body 100 at equal angular intervals on a circle of a second diameter greater than the first diameter. A wafer W is supported on the support members 113 in the substrate processing vessel 30D during processing. As shown in FIG. 14, each of the support members 113 has a body 114 and a guide 115 protruding from the top surface 114a of the body 114. The body 114 is partly embedded in a hole formed in the vessel body 100. The support member 113 is formed of PTFE, or is formed of a stainless steel coated with a PTFE coating. As best shown in FIG. 14, the height of the top surfaces 114a (i.e., support surfaces) of the bodies 114 is higher than the height of the tips (i.e., support tip) of the support pins 105 of substrate support rods 102 positioned at the lower position.

Two concentric, circular grooves having slightly different diameters are formed in a peripheral part of the upper surface of the vessel body 100. O-rings 116 and 117 are fitted in the circular grooves, respectively.

Grooves 118 and 119 having the shape of a circular arc are formed diametrically opposite to each other in a peripheral part of the upper surface of the vessel body 100 on the inner side of the O-rings 116 and 117. A supply hole 120 and a discharge hole 121 opening in the circumference of the vessel body 100 are connected to the grooves 118 and 119, respectively. Connected to the supply passage 120 is a processing fluid supply pipe 122, which is connected to the processing gas supply unit 16 (See FIG. 1). A processing fluid discharge pipe 123 is connected to the discharge hole 121. The processing fluid discharge pipe 123 is provided with a mist trap, not shown, and an ozone killer, not shown. The processing fluid containing steam and ozone and supplied through the supply passage 120 into the substrate processing vessel 30D spreads along the groove 118 and is distributed uniformly in the processing space S1. The processing fluid in the processing space S1 flows through the groove 119 into the discharge passage 121 and flows outside from the substrate processing vessel 30D. The grooves 118 and 119 ensure the uniform flow and distribution of the processing fluid in the processing space S1.

The cover 130 is a substantially disk-shaped block provided with a built-in heater 131. A circumferential wall 132 protrudes downward from a peripheral part of the lower surface of the cover 130.

The cover 130 is fixedly connected to a substantially disk-shaped cover support member 133 arranged above the cover 130. The upper ends of cylinder rods 135 of pneumatic cylinder actuators 134 (i.e., linear actuators) are connected to peripheral parts of the cover support member 133, respectively. The pneumatic cylinder actuators 134 move the cover 130 vertically between an upper position indicated in the left half part of FIG. 12 and a lower position indicate in the right half part of FIG. 12. Preferably, the pneumatic cylinder actuators 134 are disposed at equal angular intervals on a circle having its center at the center of the substrate processing vessel 30D. Since all the pneumatic cylinder actuator 109 and the pneumatic cylinder actuators 134 are disposed below the vessel body 100, the resist water-solubilizing unit can be formed in a low height.

The operation will be described.

When the cover 101 and the substrate support rods 102 are in the upper positions as shown in the left half part of FIG. 12, the wafer carrying arm 14a (FIG. 1) of the main wafer conveyer 14 carries a wafer W to a position above the substrate support rods 102, and then lowers. Thereby, the wafer W is carried by the arm 14a is transferred to the support pins 105 of the substrate support rods 102. Then, the arm 14a is moved horizontally away from a position above the vessel body 100. A locking mechanism 140 is provided for preventing the accidental fall of the cover 130 and the resulting collision of the cover 130 against the substrate carrying arm 14a, the substrate support rods 102 and the wafer lying under the cover 130 due to an unexpected air down (i.e., the failure in the air supply system for supplying working air to the pneumatic cylinder actuator 134). The locking mechanism 140 includes a locking pin 141, namely, a stopper, and an actuator 142 for horizontally moving the locking pin 141. The stopper in 141 is advanced into a space under the cover support member 133 to restrain the cover 130 from falling down.

Then, the substrate support rods 102 are lowered to their lower positions such that the heads 104 sink in the recesses 107, respectively, as shown in the right half part of FIG. 12. In this state, the O-rings 106 placed on the lower surfaces of the heads 104 are pressed against the bottom surfaces of the recesses 107, respectively. Consequently, the open ends of the through holes 108 are sealed to prevent the processing fluid from flowing from the processing space S1 into the through holes 108. As the substrate support rods 102 are lowered, the wafer W supported on the support pins 105 is transferred to the top surfaces 114a of the bodies 114 of the support members 113 (See FIG. 14). Even if the wafer W is dislocated with respect to its correct position, the wafer W is guided by the circumferences of the guides 115 to be in the correct position. The guides 115 also prevent the horizontal displacement of the wafer W during processing.

Then, the locking mechanism 140 comes into its unlocking state, the cover 130 is lowered, and the circumferential wall 132 of the cover 130 is pressed against the O-rings 116 and 117 placed on the vessel body 100. Consequently, the vessel body 100 and the cover 130 is engaged with each other in an airtight fashion, and the sealed processing space S1 is formed. Preferably, in a state where the vessel body 100 and the cover 130 are joined together; the gap between the upper surface of the vessel body 100 and the lower surface of the cover 130 is between 4 and 5 mm; the gap G1 between the upper surface of the vessel body 100 and the lower surface of the wafer W is between 0.1 and 1 mm; and the gap G2 between the lower surface of the cover 130 and the upper surface, coated with a resist film, of the wafer W is between 2 and 4 mm. Since the gap G2 is greater than the gap G1, the processing fluid flows preferentially through a space above the upper surface of the wafer W which should be preferentially processed. The processing fluid is also permitted to flow through a space under the wafer W because it is possible that the resist film adheres also to the back surface of the wafer W. As mentioned above, the processing space S1 is thin (low-profile space), and the thickness of the processing space S1 between 4 and 5 mm is not greater than about five times the thickness, usually on the order of 1 mm, of the wafer W.

A locking mechanism 145 is provided for preventing damaging the wafer W by the substrate support rods 102 accidentally raised due to an unexpected air down in a state where the cover 130 and the substrate support rods 102 are at their lower positions. The locking mechanism 145 includes a locking pin 146, namely, a stopper, and an actuator for horizontally moving the locking pin 146. The locking pin 146 is engaged in a hole formed in the rod lifting arm 111 to detain the rod lifting arm 111.

In this state, the wafer W is heated by the heater, the processing fluid containing ozone and steam is supplied at a predetermined flow rate through the supply passage 120 into the processing space S1, while discharging the processing fluid through the discharge passage 121 to process the resist film on the wafer W by a resist water-solubilizing process.

While the wafer is being processed by the resist water-solubilizing process, a leakage monitoring system 150 monitors the sealing condition. The leakage monitoring system 150 has a main line 151 for monitoring, namely, a suction line. A branch line 151a and a plurality of branch lines 151b are branched from the upstream end of the main line 151. The branch line 151a penetrates the vessel body 100 and opens into a sealed space between the O-rings 116 and 117. Each of the branch lines 151b extends through the vessel body 100 and opens into each of the through holes 108. In FIG. 12, only one of the branch lines 151b is shown for simplicity. Each through hole 108 is a sealed space because the open upper end of the through hole 108 is sealed by the O-ring 106 and the lower end of the through hole 108 is connected to the bellows 112. A pressure gage 152, a shutoff valve 153, an ejector 154 and a selector valve 155 are arranged in the main line 151, from the upstream side thereof in that order. An ozone process line 156 is branched from the main line 151 at the selector valve 155. An ozone killer 157 and an ejector 158 are arranged in the ozone process line 156, from the upstream side thereof in that order. The downstream end of the ozone process line 156 is joined to the main line 151.

The shutoff valve 153 is opened and the ejector 154 is operated, after the cover 130 and the substrate support rods 102 is lowered to their lower positions, the wafer W is accommodated in the substrate processing vessel 30D and the supply of the processing fluid is started. When the sealing by the O-rings 116, 117 and 106 functions properly, the pressure detected by the pressure gage 152 is a predetermined negative pressure. If not properly sealed, the pressure detected by the pressure gage 152 is a positive pressure, or a negative pressure different from the predetermined negative pressure. When such an abnormal pressure is detected, the substrate processing system gives the operator a warning. At the same time, the selector valve 155 is switched, and the ozone killer 157 and the ejector 158 are operated. Thus, the leaked fluid flows into the ozone process line 156. Ozone contained in the leaked processing fluid is detoxified by the ozone killer 157, flows into the main line 151, and discharged into a factory exhaust system, not shown. An ozone sensor may be placed in the main line 151, and the leaked fluid may be sent into the ozone process line 156 only when the ozone sensor senses ozone.

After the completion of the resist solubilizing process, the substrate processing vessel 30D is purged by nitrogen gas. Then, the cover 130 is raised and the substrate support rods 102 are raised to lift up the wafer W. Subsequently, the wafer carrying arm 14a advances into the space under the wafer W, rises to receive the wafer W from the substrate support rods 102, and carries the wafer W to the cleaning unit. Then, a procedure similar to that previously explained in connection with the other embodiment is carried out.

Although the invention has been described in its preferred embodiments, the present invention is not limited thereto in its practical application. The characteristic components of each of the embodiments are can be incorporated into the other embodiments. For example, the stage 44a of the vessel body 41a of the substrate processing vessel 30 shown in FIGS. 4 to 6 may be provided in its surface with members corresponding to the support members 113 included in the substrate processing vessel 3D shown in FIGS. 12 to 14. When the stage 44a of the vessel body 41a of the substrate processing vessel 30 is provided with such members corresponding to the support members 113, the wafer W is transferred from the support members 48 to the member corresponding to the support members 113 as the support members 48 supporting the wafer W are lowered. Then the support members 48 move further down and closes the through holes 47. The substrate processing vessels 30A to 30D may be provided with the locking mechanism 35 shown in FIGS. 7 and 8.

Although the invention has been described on an assumption that the workpiece is a semiconductor wafer, the workpiece is not limited thereto and may be a glass substrate for a liquid crystal display (LCD).

As apparent from the foregoing description, the substrate processing vessel of the present invention does not need any member corresponding to the long substrate support pins, permanently projecting into the processing space, of the conventional substrate processing vessel. Therefore, the substrate processing vessel can be designed such that a thin processing space having a small volume and conforming to the shape of a substrate is defined therein. Thus the amount of the processing gas to be supplied into the substrate processing vessel can be reduced and the processing gas can be effectively used. Consequently, the running cost of the substrate processing system can be reduced and the throughput can be increased. When the substrate processing vessel is provided with a heater, the substrate can be quickly heated in a highly uniform temperature distribution. Consequently, the quality of the processed substrate can be improved and the throughput can be increased. Since the leakage of the processing fluid from the substrate processing vessel is prevented by a simple structure, the substrate processing vessel including the auxiliary parts can be formed in a thin structure. Thus, a system built by stacking a plurality of substrate processing vessels like the substrate processing vessel of the present invention can be formed in s small size.

1. A substrate processing vessel for processing therein a substrate with a processing fluid, comprising:
a vessel body;
a cover adapted to be separatably and hermetically joined to the vessel body to define a processing space together with the vessel body;
a plurality of substrate support rods incorporated into the vessel body; and
a driving device adapted to vertically move the substrate support rods between a first vertical position and a second vertical position;
wherein each of the substrate support rods has a head adapted to support a substrate from below the same, and a shank extending downward from the head,
the vessel body is provided with a plurality of vertical bores each having an open upper end opening into the processing space, and the shanks of the substrate support rods are vertically movably inserted in the bores, respectively,
the head of each substrate support rod is sized such that the head is unable to pass through the bore of the vessel body, and the heads of the substrate support rods are configured to close the open upper ends of the bores when the substrate support rods are held at the first vertical position.

2. The substrate processing vessel according to claim 1, wherein the head of each substrate support rod is provided with an elastic sealing member that is brought into contact with a part, around the open upper end of the bore, of the vessel body to prevent the processing fluid from flowing from the processing fluid into the bore when the substrate support rod is held at the first vertical position.

3. The substrate processing vessel according to claim 2, wherein an upper surface of the vessel body is provided with recesses adapted to receive the heads of the substrate support rods held at the first vertical position, respectively, and the bores of the vessel body extend downward from the bottom surfaces of the recesses, respectively, and the elastic sealing members arranged so that they are brought into contact with the bottom surfaces of the recesses, respectively.

4. The substrate processing vessel according to claim 1, wherein the head of each of the substrate support rods has an outer circumference tapering downward, and an inner circumference of each of the bores adjacent to an upper end portion of each of the bores has a shape complementary to the tapered outer circumference of the head of each of the substrate support rods, whereby each of the outer circumferences and each of the inner circumferences are in close contact with each other to form a seal that prevents a processing fluid from flowing from the processing space to each of the bores when the substrate support rod is held at the first vertical position.

5. The substrate processing vessel according to claim 1 further comprising a plurality of substrate support members arranged on the vessel body to support the substrate from below the same,
wherein substrate support surfaces of the substrate support members are at a height higher than that of substrate support surfaces of the heads of the substrate support rods at the first vertical position, whereby the substrate is supported by the substrate support members without being supported by the substrate support rods when the substrate support rods are at the first vertical position.

6. The substrate processing vessel according to claim 1, wherein the driving device includes:
arms respectively connected to the shanks of the plurality of substrate support rods projecting downward from lower ends of the bores of the vessel body, the arm being arranged under a bottom surface of the vessel body; and
an actuator adapted to move the arms vertically.

7. The substrate processing vessel according to claim 6 further comprising bellows respectively surrounding the shanks of the plurality of substrate support rods projecting down from the lower ends of the bores of the vessel body,
wherein each of the bellows has an upper end hermetically connected to a part, around the lower end of the bore, of the vessel body, and a lower end hermetically connected to the arm.

8. The substrate processing vessel according to claim 6 further comprises an arm locking mechanism having a stopper adapted to separatably engage with the arm to lock the arm.

9. The substrate processing vessel according to claim 1 further comprising:
an actuator adapted to move the cover vertically; and
a cover locking mechanism having a stopper adapted to separatably engage with the cover or a member fixed to the cover to lock the cover.

10. The substrate processing vessel according to claim 1, wherein said vessel has a sealing part for preventing leakage of the processing fluid from the processing space, and a sealed space is defined on a side of the sealing part opposite to a processing-space side of the sealing part,
said substrate processing vessel further comprising a suction line connected to the sealed space, and a pressure gage placed in the suction line, whereby leakage of the processing fluid through the sealing part can be detected by measuring pressure in the sealed space by the pressure gage.

11. The substrate processing vessel according to claim 10, wherein the sealed space is the bore of the processing vessel receiving the shank of the substrate support rod.

12. The substrate processing vessel according to claim 10, wherein a joint of the vessel body and the cover is sealed by a first sealing member and a second sealing member disposed on an outer side of the first sealing member, and the sealed space is a space defined by the first and the second sealing member.

13. The substrate processing vessel according to claim 10, an ozone process line provided with an ozone killer is connected to the suction line.

14. The substrate processing vessel according to claim 1, wherein the driving device includes a piston connected to the substrate support rods, a cylinder surrounding the piston, and a working fluid supply system adapted to supply a working fluid to the cylinder.

15. The substrate processing vessel according to claim 1 further comprising an actuator adapted to move the cover vertically, and springs pushing the substrate support rods upward;
wherein:
the cover is provided with a pressing member adapted to come into contact with the heads of the substrate support rods to depress the substrate support rods against resilience of the springs when the cover is lowered; and
the driving device includes the springs, the actuator and the pressing member.

16. The substrate processing vessel according to claim 1 further comprising a vessel locking mechanism adapted to force the vessel body and the cover to closely join together and prevent separation of the cover from the vessel body, when the cover contacts the vessel body.
